(19) United States
(12) Patent Application Publication
(10) Pub. No.: US 2024/0182670 A1
(43) Pub. Date: Jun. 6, 2024

(54) GEOSYNTHETICS WITH GRAPHENE

(71) Applicant: Groupe Solmax, Inc., Varennes (CA)

(72) Inventors: David Michael Jones, Buford, GA (US); Peter Bauer, Longueuil (CA); Farid Djennadi, Montreal (CA); Vincent Philippe Guillette, Vercheres (CA)

(73) Assignee: Groupe Solmax, Inc., Varennes (CA)

(21) Appl. No.: 18/526,469

(22) Filed: Dec. 1, 2023

Related U.S. Application Data
(60) Provisional application No. 63/429,732, filed on Dec. 2, 2022.

(51) Int. Cl. C08K 3/04; C08K 3/014

(52) U.S. Cl. CPC C08K 3/042; C08K 3/014

(57) ABSTRACT

According to embodiments, a geosynthetic structure includes a base resin polymeric matrix including an admixture. The geosynthetic structure further includes a graphene material impregnated into the base resin polymer matrix and in a final amount of about 0.10 weight percent to about 5 weight percent. The geosynthetic structure also includes a stabilizer impregnated within the base resin polymer matrix.

### CROSS-REFERENCE TO RELATED APPLICATION

This application claims priority to and the benefit of U.S. Provisional Patent Application No. 63/429,732, filed on Dec. 2, 2022, which is incorporated by reference herein in its entirety by reference.

### BACKGROUND

The present disclosure relates to geosynthetics, and more specifically to, geosynthetics with graphene.

Geosynthetics, including geomembranes and geotextiles, are used around the globe in containment applications. Such materials are used to contain contaminants generated, for example, by the exploitation of mines, waste management, and petrochemistry, as well as to impound water or as structural barriers. Maintaining integrity of the geosynthetic structure is key to environmental protection for multiple applications such as mining, waste management and aquaculture.

### SUMMARY

According to embodiments, a geosynthetic structure includes a base resin polymeric matrix including an admixture. The geosynthetic structure further includes a graphene material impregnated into the base resin polymer matrix and in a final amount of about 0.10 weight percent to about 5 weight percent. The geosynthetic structure also includes a stabilizer impregnated within the base resin polymer matrix.

According to other embodiments, a geosynthetic structure includes a plurality of layers. At least one layer of the plurality of layers is a graphene layer and includes a base resin polymeric matrix with an admixture; a graphene material impregnated into the base resin polymer matrix and in a final amount of about 0.10 weight percent to about 5 weight percent; and a stabilizer impregnated within the base resin polymer matrix.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 is a schematic partial cross-section of a geosynthetic structure;

FIG. 2 is a schematic partial cross-section of a geosynthetic structure with a plurality of layers;

FIG. 3 is a graph showing extruder torque measured for samples with various amounts of carbon black or graphene;

FIG. 4 is a graph showing extruded weight measured for samples with various amounts of carbon black or graphene;

FIG. 5 is a graph showing extrusion efficiency measured for samples with various amounts of carbon black or graphene;

FIG. 6 is an image of a surface of a geomembrane with graphene; and

FIG. 7 is a schematic of a surface of a geomembrane with graphene, illustrating asperity height calculations.

### DETAILED DESCRIPTION

Maintaining the integrity of geosynthetics in the field is challenging when the materials used in applications, such as mining, waste management, and aquaculture, all have harsh environments. The long-term behavior of geosynthetics, such as geomembranes, when used as landfill-based liners, is initially controlled by the rate of extraction of antioxidants from the geosynthetic materials. This process involves the dissolution or chemical reaction of antioxidants at the surface of the geosynthetic, and their diffusion from the core structure to the surface due to concentration gradient. The loss of antioxidants leaves the geosynthetic vulnerable to oxidative degradation. Other contributors to the degradation of geosynthetic mechanical properties include, for example, high temperatures, which accelerate degradation, and oxidation from energy sources such as ultraviolet (UV) radiation.

Stabilizing systems, including stabilizing additives, are added to geosynthetics to mitigate oxidative damage. However, one challenge is that stabilizing additives are readily depleted from the geosynthetics over time due to exposure to ultraviolet (UV) light, air, water, and/or other chemicals. As stabilizers become depleted, they cannot mitigate oxidative damage to the geosynthetics.

Carbon black can be used as part of stabilizing system in geosynthetics. However, carbon black is generally not desirable for various environmental reasons. For example, carbon black is made from fossil fuels, and therefore, produces carbon dioxide, carbon monoxide, and other greenhouse gases as harmful and undesired by-products. Carbon black also contains polycyclic aromatic hydrocarbons, which can be harmful to animals.

Thus, there is a need to provide a stabilizer system for geosynthetics that not only provides protection from oxidation, but also protects against extraction of the protective stabilizers by physical means, such as by ultraviolet (UV) rays, air, and/or water. Further, there is a need for an alternative stabilizer system to those that include only carbon black, which is environmentally harmful and has the drawbacks described above.

Accordingly, described herein are geosynthetics that include graphene impregnated throughout the entire structure, or with graphene impregnated within one or more layers. In some embodiments, the geosynthetic structures include a base resin polymeric matrix comprising an admixture, a graphene material impregnated into the base resin polymer matrix and in a final amount of about 0.10 weight percent to about 5 weight percent by total weight of either the geosynthetic structure when impregnated throughout, or by total weight of the graphene layer when graphene is only included in a discrete layer, and a stabilizer impregnated within the base resin polymer matrix. The graphene material and the stabilizer form the stabilizing system, which provides enhanced ultraviolet (UV) stability and mechanical properties.

In some embodiments, the graphene material is used as a substitute for carbon black and thereby provides advantages of being environmentally friendly. The graphene material is made from natural graphite, instead of from fossil fuels, does not produce carbon monoxide, carbon dioxide, or greenhouse gas by-products, and does not include carcinogenic polycyclic aromatic hydrocarbons. Further, in some embodiments, adding graphene in place of carbon black, or synergistically with carbon black, can produce specifically-targeted membrane properties, as well as render the membrane conductive, thinner, and/or stronger.

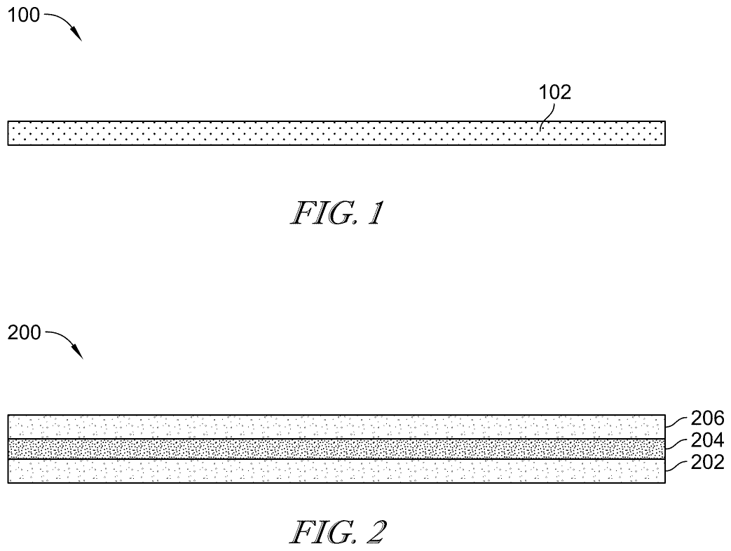

FIG. 1 illustrates a geosynthetic structure 100 according to embodiments of the present invention. The geosynthetic structure 100 is a geomembrane, a geonet, or a geotextile.

The geosynthetic structure 100 is formed from extruded material, fibers, and/or yarns that include a base polymer matrix. Non-limiting examples of polymers for the base polymeric matrix include high density polyethylene, medium density polyethylene, linear low-density polyethylene, low-density polyethylene, ultra-low density polyethylene, or any combination thereof. Other non-limiting examples of polymers for the base polymeric matrix include polypropylene, polyethylene, polyvinyl chloride, acrylonitrile butadiene styrene, a co-polymer of any of the foregoing, or any combination thereof. In one or more embodiments, the polymeric matrix includes a polyolefin mixture, a plastomer, a viscoelastomer, carbon nanofibrils, or a combination thereof.

The geosynthetic structure 100 includes a graphene material 102 impregnated into the base resin polymer matrix. In one or more embodiments, the graphene material 102 is substantially evenly distributed throughout the entire geosynthetic structure. In other embodiments, the graphene material 102 is impregnated in one or more layers, as set forth in further detail below.

Non-limiting examples of the graphene material 102 include graphene particles, graphene nanoparticles, graphene nanofillers, graphene nanocomposites, graphene platelets, graphene powder, graphene concentrate, graphene compound, graphene masterbatch, or a combination thereof. According to one or more embodiments, the graphene material is graphene platelets.

The graphene material 102 is a two-dimensional carbon material with an average primary particle size of about 0.1 to about 30 micrometers in some embodiments. In other embodiments, the graphene material 102 has an average primary particle size of about 0.5 to about 2 micrometers. In one or more embodiments, the graphene material 102 has an average primary particle size about or in any range between about 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30 micrometers.

The graphene material 102 includes about 1 to about 50 atomic layers in some embodiments. In other embodiments, the graphene material 102 includes about 6 to about 10 atomic layers. In some embodiments, the graphene material includes about or in any range between about 1, 2, 3, 4, 5, 6, 7, 8, 9, and 10, 11, 12, 13, 14, 15, 16, 17, 18, 19, 20, 21, 22, 23, 24, 25 26, 27, 28, 29, 30, 31, 32, 33, 34, 35, 36, 37, 38, 39, 40, 41, 42, 43, 44, 45, 46, 47, 48, 49, and 50 atomic layers.

In one or more embodiments, the graphene material 102 has a graphene purity of at least 90 percent at a thickness of about 1 to about 10 atomic layers. In other embodiments, the graphene material 102 has a graphene purity of at least 95 percent at a thickness of about 1 to about 10 atomic layers. In one or more embodiments, the graphene material 102 has a purity about or in any range between about 90, 91, 92, 93, 94, 95, 96, 97, 98, and 99 percent at a thickness of about or in any range between about 1, 2, 3, 3, 4, 5, 6, 7, 8, 9, and 10 atomic layers.

The graphene material 102 has a carbon content of more than 96 weight percent carbon in some embodiments. Yet, in other embodiments, the graphene material 102 has a carbon content about or in any range between about 96, 97, 98, 99, and 99.9 weight percent.

In one or more embodiments, the graphene material 102 has an oxygen content of less than 1 weight percent. Still in other embodiments, the graphene material 102 has an oxygen content of about or in any range between about 0.1, 0.2, 0.3, 0.4, 0.5, 0.6, 0.7, 0.8, 0.9, and 1.0 weight percent.

In some embodiments, the graphene material 102 is impregnated into the base resin polymer matrix of the geosynthetic structure, or a layer of the geosynthetic structure, and in a final amount of about 0.10 weight percent to about 5 weight percent. In other embodiments, the graphene material 102 is impregnated into the base resin polymer matrix of the geosynthetic structure, or a layer of the geosynthetic structure, and in a final amount of about 0.5 weight percent to about 3.0 weight percent. In one or more embodiments, the graphene material 102 is impregnated into the base resin polymer matrix of the geosynthetic structure, or a layer of the geosynthetic structure, and in a final amount of about or in any range between about 0.5, 1.0, 1.5, 2.0, 2.5, 3.0, 3.5, 4.0, 4.5, and 5.0 weight percent.

When weight percentages of graphene, carbon black, stabilizers, or other additives are recited herein, the weight percentages within geosynthetic structures are percentages by total weight of the geosynthetic structure when distributed throughout the structure, or by total weight of a single layer within the geosynthetic structure, when within a single layer. Reference to a geosynthetic structure is a single layer structure or a multiple layer structure.

The geosynthetic structure 100 further includes a stabilizer impregnated within the base resin polymeric matrix. Non-limiting examples of the stabilizer include an antioxidant, a radical scavenger, a hindered amine light stabilizer, or a combination thereof. Non-limiting examples of antioxidants include phenolics, phosphates, phosphites, phosphonites, or any combination thereof. Non-limiting examples of radical scavengers include sterically hindered phenols, thioethers, hindered amine light stabilizers (e.g., Irganox 1010 and similar additives), or any combination thereof.

According to some embodiments, the geosynthetic structure 100 with the graphene material 102 in the base resin polymeric matrix does not include carbon black, or is substantially free of carbon black, rendering it environmentally friendly. As used herein, in some embodiments, “substantially free” when used in the context of carbon black content means that the geosynthetic structure 100 with the graphene material 102 in the base resin polymeric matrix includes less than 2%, less than 1.5%, less than 1%, less than 0.5%, less than 0.1%, or less than 0.01% carbon black. As used herein, in other embodiments, “substantially free” when used in the context of carbon black content means that the geosynthetic structure 100 with the graphene material 102 in the base resin polymeric matrix includes 0% carbon black.

In some embodiments, the geosynthetic structure 100 with the graphene material 102 in the base resin polymeric matrix further includes carbon black. In some embodiments, the geosynthetic structure 100 includes about 0.01% to about 3.0% graphene material 102 and about 0.1 to about 3.0% carbon black in a base resin polymeric matrix. In other embodiments, the geosynthetic structure 100 includes about 0.1% to about 2.0% graphene material 102 and about 0.1 to about 2.0% carbon black in a base resin polymeric matrix. Still in other embodiments, the geosynthetic structure 100 includes graphene in an amount about or in any range between about 0.1%, 0.25%, 0.75%, 1.5%, 2.0%, 2.5%, and 3.0%; carbon black in an amount about or in any range between about 0.1%, 0.25%, 0.75%, 1.5%, 2.0%, 2.5%, and 3.0%; and a base resin polymeric matrix.

The geosynthetic structure 100 includes one layer in some embodiments, as shown in FIG. 1. In other embodiments, the geosynthetic structure 200 includes a plurality of layers, including two layers, three layer, four layers, or more, in one or more embodiments, as shown in FIG. 2.

The geosynthetic structure 200 in FIG. 2 includes three layers, first layer 202 (first skin structure), second layer 204 (core structure), and third layer 206 (second skin structure). In some embodiments, at least one layer of the plurality of layers does not include or is substantially free of graphene. For example, in one or more embodiments, the second layer 204 is substantially free of graphene, and the first layer 202 and the third layer 206 include graphene. In one or more embodiments, the first layer 202, the second layer 204, the third layer 206, or any combination thereof, includes the graphene material. In other embodiments, the first layer 202, the second layer 204, the third layer 206, or any combination thereof is substantially free of the graphene material. In some embodiments, the term “substantially free” of the graphene material means about or in any range between about 3.0%, 2.5%, 2.0%, 1.5%, 1.0%, 0.5%, 0.1%, 0.01%, and 0% graphene material.

In embodiments, a geosynthetic structure includes a plurality of layers, wherein at least one layer of the plurality of layers is a graphene layer. The graphene layer includes a base resin polymeric matrix with an admixture; a graphene material impregnated into the base resin polymer matrix and in a final amount of about 0.10 weight percent to about 5 weight percent; and a stabilizer impregnated within the base resin polymer matrix. In some embodiments, at least one layer of the plurality of layers is substantially free of graphene.

In one or more embodiments, the geosynthetic structure is a geomembrane, and the plurality of layers include a core structure, a first skin structure, and a second skin structure, with the core structure being the graphene layer.

The layers of the plurality of layers have different properties, or the same properties. In one or more embodiments, at least one or more of the layers (first layer 202, second layer 204, and/or third layer 206) is insulative, with an insulative/insulating measurement of at least 1.0×10¹² Ohms, as measured in accordance with ASTM D257 test method. In some embodiments, the first layer 202, the third layer 206, or both layers, is insulative, with an insulative/insulating measurement of at least 1.0×10¹² Ohms, as measured in accordance with ASTM D257 test method. In some embodiments, the first layer 202, the third layer 206, or both layers, is insulative, with an insulative/insulating measurement of at least 1.0×10¹² Ohms, as measured in accordance with ASTM D257 test method.

In other embodiments, at least one or more of the layers (first layer 202, second layer 204, and/or third layer 206) is conductive, with a conductivity equal to or less than 1.0×10⁴ Ohms, as measured in accordance with ASTM D257 test method. In some embodiments, at least one or more of the layers (first layer 202, second layer 204, and/or third layer 206) is conductive, with a conductivity equal to or less than 1.0×10³ Ohms, as measured in accordance with ASTM D257 test method. Yet, in other embodiments, at least one or more of the layers (first layer 202, second layer 204, and/or third layer 206) is conductive, with a conductivity equal to or less than 1.0×10² Ohms, as measured in accordance with ASTM D257 test method.

In some embodiments, the second layer 204 (core structure) includes a combination of graphene and carbon black in a base resin polymeric matrix, resulting in a conductive material. In other embodiments, the second layer 204 (core structure) includes a combination of about 2% to about 14% graphene and about 2% to about 14% carbon black in a base resin polymeric matrix, resulting in a conductive material. Yet, in other embodiments, the second layer 204 (core structure) includes a combination of about 5% to about 10% graphene and about 5% to about 10% carbon black in a base resin polymeric matrix, resulting in a conductive material. In one or more other embodiments, the second layer 204 (core structure) includes graphene in an amount about or in any range between about 2%, 3%, 4%, 5%, 6%, 7%, 8%, 9%, 10%, 11%, 12%, 13%, and 14%; carbon black in an amount about or in any range between about 2%, 3%, 4%, 5%, 6%, 7%, 8%, 9%, 10%, 11%, 12%, 13%, and 14%; and a base resin polymeric matrix.

In embodiments in which the second layer 204 (core structure) includes a combination of graphene and carbon black in a base resin polymeric matrix, resulting in a conductive material. In some embodiments, the first layer 202 (first skin), second layer 204 (core structure), and/or third layer 206 (second skin) includes a combination of graphene and carbon black.

In one or more embodiments, the first layer 202 (first skin structure) and/or the second layer 206 (second skin structure) is conductive, reflective, colored, anti-static, flame-retardant, smooth, textured, or a combination thereof.

According to some embodiments, the first layer 202 (first skin), the third layer (second skin), or both is reflective. Yet, according to other embodiments, the first layer 202 (first skin), the third layer (second skin), or both is not reflective. In one or more embodiments, the term reflective means an average of least 50% solar energy reflectance as measured as direct normal irradiance according to ASTM E903-20 test method. In other embodiments, the term reflective means an average of least 70% solar energy reflectance as measured as direct normal irradiance according to ASTM E903-20 test method. Still, in some embodiments, the term reflective means an average of least 10%, at least 20%, at least 30%, at least 40%, at least 50%, at least 60%, at least 70%, at least 80%, at least 90%, at least 95%, or at least 99% solar energy reflectance as measured as direct normal irradiance according to ASTM E903-20 test method.

In some embodiments, the first layer 202 (first skin), the third layer (second skin), or both include one or more reflective additives, e.g., pigments, to render it reflective. Non-limiting examples of such additives include barium sulfate, titanium dioxide, zinc oxide, lead oxide, or a combination thereof. In some embodiments, the reflective additives are included in an amount of about 5% to about 20% by total weight of the layer. In other embodiments, the reflective additives are included in an amount of about 10% to about 15% by total weight of the layer. Still, in other embodiments, the reflective additives are included in an amount about or in any range between about 5%, 6%, 7%, 8%, 9%, 10%, 11%, 12%, 13%, 14%, 15%, 16%, 17%, 18%, 19%, and 20% by total weight of the layer.

In embodiments, the first layer 202 and the second layer 204 have different polymer compositions, different textures, or both different polymer compositions and different textures. In other embodiments, two of or all of the first layer 202, the second layer 204, and the third layer 206, have different polymer compositions, different textures, or both different polymer compositions and different textures.

The geosynthetics described herein are static dissipative materials, which are desirable in various applications because they prevent electric charges from rapidly flowing through the materials, which can be safety hazards. In one or more embodiments, the geosynthetic structures described herein have a static dissipative of about 1.0×10⁶ to about 1.0×10¹¹ Ohms, as measured in accordance with ASTM D257 test method. In other embodiments, the geosynthetic structures described herein have a static dissipative of about 1.0×10⁷ to about 1.0×10⁹ Ohms, as measured in accordance with ASTM D257 test method. In some embodiments, the geosynthetic structures described herein have a static dissipative about or in any range between about 1.0×10⁶, 1.0×10⁷, 1.0×10⁸, 1.0×10⁹, 1.0×10¹⁰, and about 1.0×10¹¹ Ohms, as measured in accordance with ASTM D257 test method.

The geosynthetics described herein are favorably conductive. In some embodiments, the first layer 202, the third layer 204, or both layers, is conductive. In one or more embodiments, the geosynthetic structures described herein have a conductivity equal to or less than 1.0×10⁴ Ohms, as measured in accordance with ASTM D257 test method. In other embodiments, the geosynthetic structures described herein have a conductivity equal to or less than 1.0×10³ Ohms, as measured in accordance with ASTM D257 test method. In some embodiments, the geosynthetic structures described herein have a conductivity equal to or less than 1.0×10² Ohms, as measured in accordance with ASTM D257 test method.

In one or more embodiments, the geosynthetic structures described herein have an insulative measurement of at least 1.0×10¹² Ohms, as measured in accordance with ASTM D257 test method. In other embodiments, the geosynthetic structures described herein have an insulative measurement of at least 1.0×10¹³ Ohms, as measured in accordance with ASTM D257 test method. In some embodiments, the geosynthetic structures described herein have an insulative measurement of at least 1.0×10¹⁴ Ohms, as measured in accordance with ASTM D257 test method.

In some embodiments, the geosynthetic structures have at least 1.5 times higher solar reflective index when compared to a geosynthetic structure without graphene material as measured according to ASTM E903-20. In other embodiments, the geosynthetic structures have about 1.5 to about 2.0 times higher solar reflective index when compared to a geosynthetic structure without graphene material as measured according to ASTM E903-20.

In other embodiments, the geosynthetic structures have a high pressure oxidative induction time (HP-OIT) increase of at least 15% compared to a same geosynthetic structure with the same base resin polymeric matrix and 2.5% carbon black instead of the graphene material, as measured by ASTM D3895 or ASTM D5885 test methods. In some embodiments, the geosynthetic structures have a high pressure oxidative induction time (HP-OIT) increase of about 15% to about 20% compared to a same geosynthetic structure with the same base resin polymeric matrix and 2.5% carbon black instead of the graphene material, as measured by ASTM D3895 or ASTM D5885 test methods.

ASTM tests D3895 and D5885 measure stabilizer suitability, via oxidative induction time (OIT). ASTM D3895 is the standard test method for OIT of polyolefins by differential scanning calorimetry. ASTM D5885 is the standard test method for OIT of polyolefin geosynthetics by high-pressure differential scanning calorimetry. The ASTM D5885 test is conducted at a lower temperature (150 degrees Celsius) with elevated pressures relative to the ASTM D3895 test. The tests include placing a small sample of the material in an apparatus that measures heat and energy, with the apparatus then heated. Oxygen is introduced into the system, which causes the sample material to oxidize, with the stabilizing system suppressing oxidation. Eventually the stabilizers are completely consumed, whereby the material sample begins to combust, and additional energy is given off. The HP-OIT is therefore a measure of the material's stability.

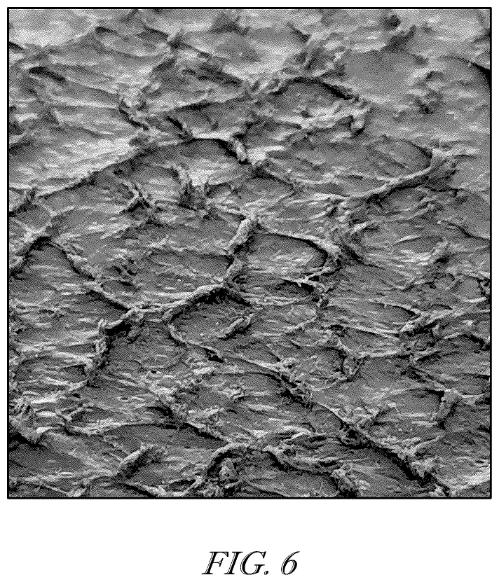

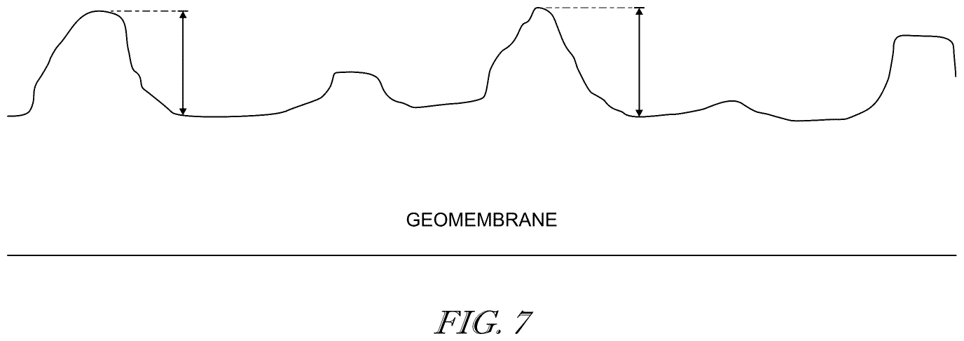

Unexpectedly, the surface roughness of geosynthetics, in particular, geomembranes, is higher with graphene (in the skins or outer external layers) compared to carbon black, as shown in FIG. 6. Surface roughness is measured according to ASTM D7466 test, which measures asperity height to assess the degree of surface roughness. As shown in FIG. 7, the asperity height is determined by measuring peak-to-valley distances for a maximum of three measurements. The outer faces of graphene geomembranes are rougher than those with carbon black, which is unexpected because the two-dimensional graphene has a higher surface area. Three-dimensional, spherical carbon black particles with smaller surface area would presumably create more surface roughness, and thereby greater measured asperity heights, but this is not what was observed. High surface roughness is a desired property for many geosynthetic applications.

According to one or more embodiments, geosynthetic structures with graphene in one or both external/outer layers are texturized by one or more processes. Including graphene in external/outer layers allows for more effective texturizing. In one or more embodiments, geosynthetic structures with 1% graphene in an external/outer layer have at least a 20% higher asperity height as measured by ASTM D7466 test compared to a geosynthetic structure with 2.5% carbon black. In other embodiments, geosynthetic structures with 1% graphene in an external/outer layer have at least 10% higher asperity height as measured by ASTM D7466 test compared to a geosynthetic structure with 2.5% carbon black. In some embodiments, geosynthetic structures with 1% graphene in an external/outer layer have at least 5%, at least 10%, at least 15%, or at least 20% higher asperity height as measured by ASTM D7466 test compared to a geosynthetic structure with 2.5% carbon black.

### EXAMPLES

### Example 1: Extrusion Efficiency

Samples of a high density polyethylene homopolymer (control) were extruded and compared to extruded samples with graphene or carbon black (CB) masterbatches. The mixtures were prepared on a lab extruder, without a die (screw diameter 0.5 inch), and the temperature settings were constant for all trials.

The following materials were extruded at three different extrusion speeds (75 rpm, 100 rpm and 125 rpm): (1) polyethylene copolymer (reference control); (2) polyethylene copolymer with graphene in 1%, 2%, 3%, 5% (weight percent); and (3) polyethylene copolymer with carbon black in 1%, 2%, 3%, 5% (weight percent).

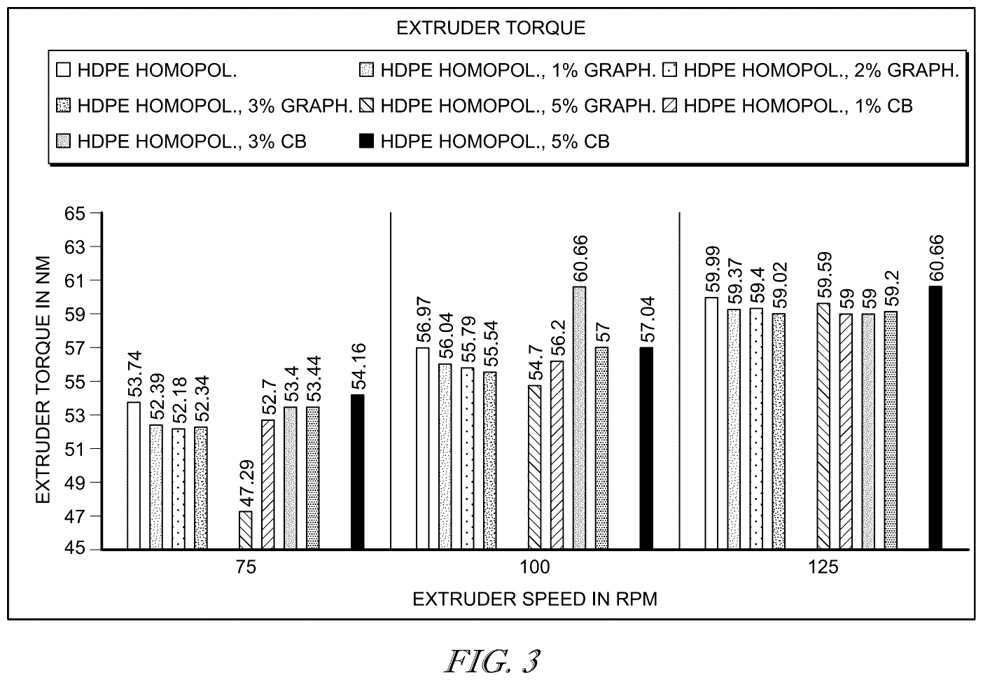

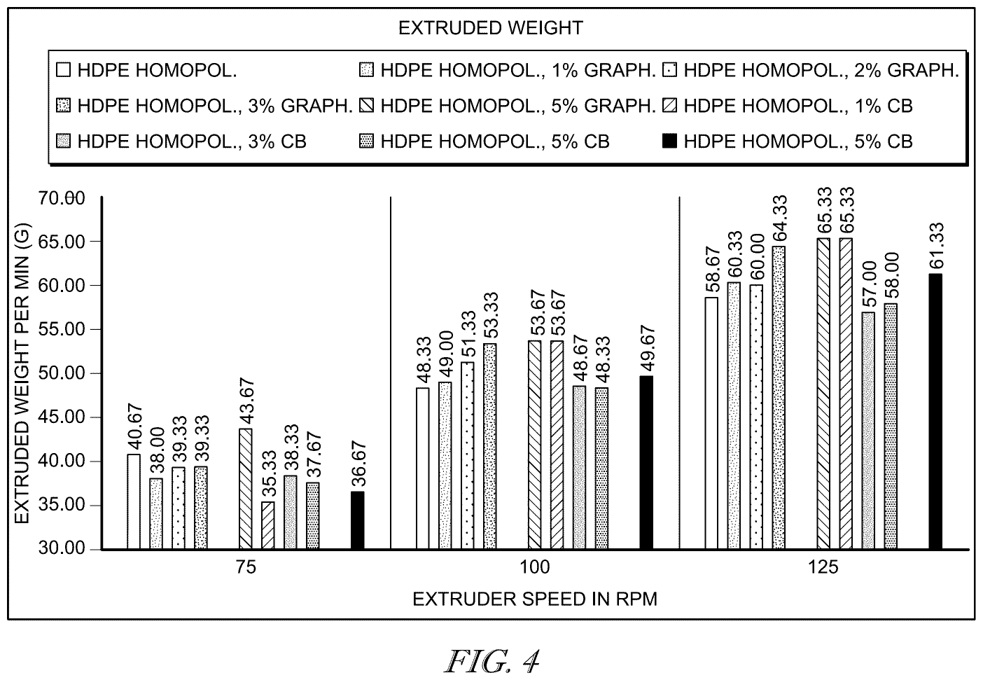

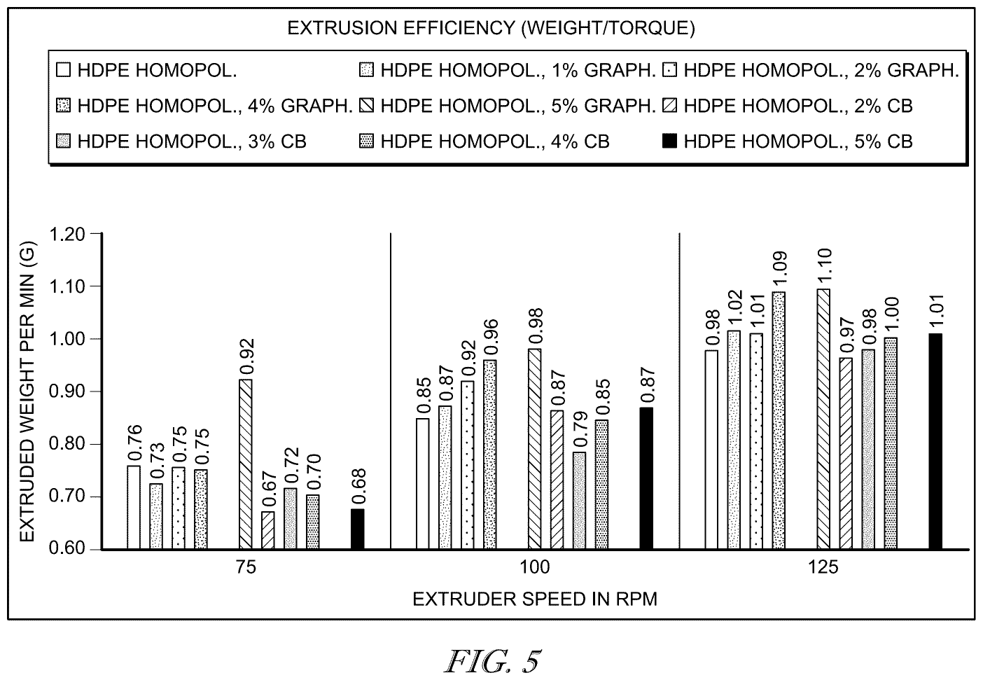

The extruded weights were measured in triplicate for 60 seconds of extrusion. The averaged extruded mass per minute was calculated. The torque was also measured by the extruder and used as an indication of the energy intake. The results are shown in FIGS. 3-5 for torque (FIG. 3), and extruded weight (FIG. 4), as well for extruded mass/torque (FIG. 5).

As shown in FIG. 4, an increase in graphene increased the extruded weight for all of the extrusion speeds. However, increasing the carbon black content did not significantly impact the extruded weight.

As shown in FIG. 3, the torque decreased with increased amounts of graphene. In contrast, the torque slightly increased with increasing amounts of carbon black content.

These data demonstrated that graphene had an unexpected effect on both extruder torque (i.e., a decrease in torque with increasing graphene), as well as energy consumption (i.e., decreased energy consumption with increasing graphene).

FIG. 5 shows that graphene exceeded the performance of carbon black for all tested speed and weight percent combinations.

### Example 2: Reflectivity

The reflectivity of geomembranes with 1% graphene (Table 2), and controls without graphene (Table 1), were measured according to ASTM E903-20. A UV/VIS/NIR spectrophotometer with a spectral range of 350 to 2500 nanometers was used for the measurements.

As shown in Tables 1 and 2 below, the graphene geomembrane reflected 11.1% of the incoming solar energy, a significant increase compared to a reflectivity of only 4.71% for the control geomembrane without graphene. This data showed that the graphene decreased the accumulated heat in the exposed areas of the membrane.

TABLE 1
Geomembrane control, no graphene

| | | Standard |
|---|---|---|
| | Average | deviation |
| Solar energy reflectance (%) | | |
| Direct normal irradiance | 4.71 | 0.05 |
| Global 37-degree tilt irradiance | 4.73 | 0.05 |
| Global horizontal irradiance | 4.73 | 0.05 |
| Solar reflectance index (SRI) | | |
| Direct normal irradiance | 0.0471 | 0.05 |
| Global 37-degree tilt irradiance | 0.0473 | 0.05 |
| Global horizontal irradiance | 0.0473 | 0.05 |

TABLE 2
Geomembrane with 1% graphene

| | | Standard |
|---|---|---|
| | Average | deviation |
| Solar energy reflectance (%) | | |
| Direct normal irradiance | 11.1 | 0.1 |
| Global 37-degree tilt irradiance | 11.0 | 0.0 |
| Global horizontal irradiance | 10.9 | 0.0 |
| Solar reflectance index (SRI) | | |
| Direct normal irradiance | 0.111 | 0.001 |
| Global 37-degree tilt irradiance | 0.110 | 0.000 |
| Global horizontal irradiance | 0.109 | 0.000 |

### Example 3: Asperity Heights

Asperity heights of geomembranes with 2.5% carbon black and geomembranes with 1% graphene (in the skins) were measured according to ASTM D7466 test. Asperity height measurements assess the degree of surface roughness. The results for the inner and outer faces of the geomembranes are shown below in Table 3. The outer faces of the graphene geomembrane were rougher, which was unexpected because the two-dimensional graphene has a higher surface area. Three-dimensional, spherical carbon black particles with smaller surface area would presumably create more surface roughness, and thereby greater measured asperity heights, but this was not what was observed. Other factors in manufacturing geomembrane impact asperity such as nitrogen and line speed wherein the amount of volume and pressure of gas used alter surface roughness. These conditions including the line speed were left identical, and only the graphene and carbon black were unique to each respective sample. This phenomenon is likely attributed at least in part due to its rheological and viscosity differences between the plate like structure in graphene and the spherical structure in carbon black. Even though graphene has much greater surface area than carbon black, it orients lengthwise into the direction of the flow in the molten state, allowing the material to have less viscosity and therefore is easier to push and form surface roughness.

TABLE 3
Asperity heights

| | Asperity | Asperity |
|---|---|---|
| | height, inner | height, outer |
| | face of the roll | face of the roll |
| | (mils) | (mils) |
| Carbon black | 28.80 | 34.00 |
| geomembrane | | |
| | 27.80 | 35.20 |
| | 28.00 | 32.80 |
| | 28.60 | 32.40 |
| | 29.20 | 37.80 |
| | 27.60 | 35.00 |
| | 27.00 | 37.40 |
| | Average 28.14 | Average 34.95 |
| Graphene | 28.40 | 40.60 |
| geomembrane | | |
| | 28.00 | 42.00 |
| | 29.00 | 44.60 |
| | 27.40 | 39.20 |
| | 27.00 | 40.80 |
| | 28.40 | 43.20 |
| | 28.60 | 41.80 |
| | Average 28.11 | Average 41.74 |

### Example 4: HP-OIT Measurements

High pressure oxidative induction time (HP-OIT) measurements were taken of an admixture of high density polyethylene (HDPE) and linear low density polyethylene (LLDPE) with either carbon black or graphene. ASTM 3895 was used to measure HP-OIT of admixtures with 2.5% carbon black and 0.5%, and 0.99%. The results are shown below in Table 4. The admixture with 0.99% graphene had a 15% higher HP-OIT, with measurements of 2064 compared to the same admixture with 2.5% carbon black. These data illustrated that graphene significantly increased the material's stability, even at lower weight percent.

The samples were aged for 90 days in an oven at 85 degrees Celsius, as well as exposed for 1600 hours to ultraviolet light. As also shown in Table 4 below, the initial HP-OIT is significantly increased by the use of graphene (even without added anti-oxidants or stabilizers other than the package of the base resin). The higher HP-OIT values in the graphene samples demonstrate increased levels of stabilities, which is true for both oven aging and UV.

TABLE 4
HP-OIT measurements

| | Initial HP- | After 90 aging | After 1600 hr |
|---|---|---|---|
| | OIT | (oven 85 C.) | UV |
| HDPE/LLDPE, | 1800 | 1670 | 1700 |
| 2.5% Carbon | | | |
| Black | | | |
| HDPE/LLDPE, | 2100 | 1935 | 1965 |
| 0.5% | | | |
| Graphene | | | |
| HDPE/LLDPE, | 2212 | 1935 | 1800 |
| 0.99% | | | |
| Graphene | | | |

### Example 5: Resistance to Weathering of Skin Structures

Ultra-violet-A (UVA) light aging analyses of skin structures was conducted to determine resistance to weathering according to NF EN 12224-2000 test method. Solar absorbance, reflectance, and transmittance of skin structures were measured by exposing the skins to UVA light according to ASTM E903-20 test method, under conditions set forth in Table 5. The skin structures were high density polyethylene (HDPE) with stabilizers and pigments.

TABLE 5
Test conditions

| TEST | CONDITIONS | METHOD |
|---|---|---|
| UVA Aging | Apparatus used: Q-PANEL | NF EN |
| | QUV/spray; Lamp: UVA-340 | 12224-2000 |
| | Irradiation: 0.76 W/m²/nm @ | |
| | 340 nm | |
| | Cumulative energy, calculated | |
| | between 290 and 400 nm: | |
| | 600 MJ/m² | |
| | Duration of the test: 4680 | |
| | hours of exposure | |
| | Cycle: 5 hours of light at | |
| | 50° C. + 1 hour of | |
| | water spray at 25° C. | |
| Solar Absorbance, | Method A: Using a | ASTM E903-20 |
| Reflectance, and | spectrophotometer; | |
| Transmittance of | Apparatus used: Agilent | |
| Materials | Cary 5000 | |
| Using Integrating | UV/VIS/NIR spectrophotometer | |
| Spheres | Spectral range: 350-2500 nm | |
| | Solar energy reflectance is | |
| | calculated as per par. 8.3.1.1 | |

Initial reflectance measurements are shown in Table 6, and after subsequent exposure to increasing applied UV light intensity (215 millijoules per square meter (mJ/m²); 345 mJ/m²; 474 mJ/m²; 600 mJ/m²; and 900 mJ/m²) and subsequent testing results are shown in Tables 7-11 below. As shown, the skins maintained reflectivity over increasing light intensity, demonstrating their ability to resist weathering.

TABLE 6
Initial reflectance

| RESULTS: | Individual Data | | | Avg. | S.D. | % CV |
|---|---|---|---|---|---|---|
| Solar energy | | | | | | |
| reflectance (%) | | | | | | |
| Direct Normal | 76.7 | 77.4 | 77.2 | 77.1 | 0.4 | 0.5 |
| Irradiance | | | | | | |
| Global 37° Tilt | 76.3 | 76.9 | 76.7 | 76.6 | 0.3 | 0.4 |
| Irradiance | | | | | | |
| Global Horizontal | 75.4 | 76.1 | 75.8 | 75.8 | 0.4 | 0.5 |
| Irradiance: | | | | | | |
| Solar Reflectance | | | | | | |
| Index, SRI | | | | | | |
| Direct Normal | 0.767 | 0.774 | 0.772 | 0.771 | 0.004 | 0.5 |
| Irradiance | | | | | | |
| Global 37° Tilt | 0.763 | 0.769 | 0.767 | 0.766 | 0.003 | 0.4 |
| Irradiance | | | | | | |
| Global Horizontal | 0.754 | 0.761 | 0.758 | 0.758 | 0.004 | 0.5 |
| Irradiance | | | | | | |

TABLE 7
Reflectance after 215 mJ/m² UV exposure

| | | | | |
|---|---|---|---|---|
| RESULTS: | Individual Data | Avg. | S.D. | % CV |

After 215 mJ/m² UV exposure

| | | | | | | |
|---|---|---|---|---|---|---|
| Solar energy | | | | | | |
| reflectance (%) | | | | | | |
| Direct Normal | 77.4 | 77.4 | 77.1 | 77.3 | 0.2 | 0.2 |
| Irradiance | | | | | | |
| Global 37° Tilt | 76.9 | 76.9 | 76.6 | 76.8 | 0.2 | 0.2 |
| Irradiance | | | | | | |
| Global Horizontal | 76.0 | 76.0 | 75.7 | 75.9 | 0.2 | 0.2 |
| Irradiance: | | | | | | |
| Solar Reflectance | | | | | | |
| Index, SRI | | | | | | |
| Direct Normal | 0.774 | 0.774 | 0.771 | 0.773 | 0.002 | 0.2 |
| Irradiance | | | | | | |
| Global 37° Tilt | 0.769 | 0.769 | 0.766 | 0.768 | 0.002 | 0.2 |
| Irradiance | | | | | | |
| Global Horizontal | 0.760 | 0.760 | 0.757 | 0.759 | 0.002 | 0.2 |
| Irradiance | | | | | | |

TABLE 8
Reflectance after 345 mJ/m² UV exposure

| | | | | |
|---|---|---|---|---|
| RESULTS: | Individual Data | Avg. | S.D. | % CV |

After 345 mJ/m² UV exposure

| | | | | | | |
|---|---|---|---|---|---|---|
| Solar energy | | | | | | |
| reflectance (%) | | | | | | |
| Direct Normal | 77.1 | 76.6 | 77.0 | 76.9 | 0.3 | 0.3 |
| Irradiance | | | | | | |
| Global 37° Tilt | 76.5 | 76.1 | 76.5 | 76.4 | 0.2 | 0.3 |
| Irradiance | | | | | | |
| Global Horizontal | 75.6 | 75.2 | 75.6 | 75.5 | 0.2 | 0.3 |
| Irradiance | | | | | | |
| Solar Reflectance | | | | | | |
| Index, SRI | | | | | | |
| Direct Normal | 0.771 | 0.766 | 0.770 | 0.769 | 0.003 | 0.3 |
| Irradiance | | | | | | |
| Global 37° Tilt | 0.765 | 0.761 | 0.765 | 0.764 | 0.002 | 0.3 |
| Irradiance | | | | | | |
| Global Horizontal | 0.756 | 0.752 | 0.756 | 0.755 | 0.002 | 0.3 |
| Irradiance | | | | | | |

TABLE 9
Reflectance after 474 mJ/m² UV exposure

| | | | | |
|---|---|---|---|---|
| RESULTS: | Individual Data | Avg. | S.D. | % CV |

After 474 mJ/m² UV exposure

| | | | | | | |
|---|---|---|---|---|---|---|
| Solar energy | | | | | | |
| reflectance (%)¹ | | | | | | |
| Direct Normal | 76.8 | 76.3 | 76.6 | 76.6 | 0.3 | 0.3 |
| Irradiance: | | | | | | |
| Global 37° Tilt | 76.3 | 75.8 | 76.1 | 76.1 | 0.3 | 0.3 |
| Irradiance: | | | | | | |
| Global Horizontal | 75.4 | 75.0 | 75.3 | 75.2 | 0.2 | 0.3 |
| Irradiance: | | | | | | |
| Solar Reflectance | | | | | | |
| Index, SRI: | | | | | | |
| Direct Normal | 0.768 | 0.763 | 0.766 | 0.766 | 0.003 | 0.3 |
| Irradiance | | | | | | |
| Global 37° Tilt | 0.763 | 0.758 | 0.761 | 0.761 | 0.003 | 0.3 |
| Irradiance | | | | | | |
| Global Horizontal | 0.754 | 0.750 | 0.753 | 0.752 | 0.002 | 0.3 |
| Irradiance | | | | | | |

TABLE 10
Reflectance after 600 mJ/m² UV exposure

| | | | | |
|---|---|---|---|---|
| RESULTS: | Individual Data | Avg. | S.D. | % CV |

After 600 mJ/m² UV exposure

| Solar energy | | | | | | |
|---|---|---|---|---|---|---|
| reflectance (%) | | | | | | |
| Direct Normal | 76.9 | 76.4 | 76.9 | 76.7 | 0.3 | 0.4 |
| Irradiance | | | | | | |
| Global 37° Tilt | 76.2 | 75.9 | 76.4 | 76.2 | 0.3 | 0.3 |
| Irradiance | | | | | | |
| Global Horizontal | 76.9 | 76.4 | 75.6 | 76.3 | 0.7 | 0.9 |
| Irradiance | | | | | | |
| Solar Reflectance | | | | | | |
| Index, SRI: | ; | | | | | |
| Direct Normal | 0.769 | 0.764 | 0.769 | 0.767 | 0.003 | 0.4 |
| Irradiance | | | | | | |
| Global 37° Tilt | 0.762 | 0.759 | 0.764 | 0.762 | 0.003 | 0.3 |
| Irradiance | | | | | | |
| Global Horizontal | 0.769 | 0.764 | 0.756 | 0.763 | 0.007 | 0.9 |
| Irradiance | | | | | | |

TABLE 11
Reflectance after 900 mJ/m² UV exposure

| | | | | |
|---|---|---|---|---|
| RESULTS: | Individual Data | Avg. | S.D. | % CV |

After 900 mJ/m² UV exposure

| Solar energy | | | | | | |
|---|---|---|---|---|---|---|
| reflectance (%) | | | | | | |
| Direct Normal | 77.2 | 77.3 | 77.5 | 77.3 | 0.2 | 0.2 |
| Irradiance | | | | | | |
| Global 37° Tilt | 76.7 | 76.7 | 76.9 | 76.8 | 0.1 | 0.2 |
| Irradiance | | | | | | |
| Global Horizontal | 75.8 | 75.8 | 76.1 | 75.9 | 0.2 | 0.2 |
| Irradiance | | | | | | |
| Solar Reflectance | | | | | | |
| Index, SRI: | : | | | | | |
| Direct Normal | 0.772 | 0.773 | 0.775 | 0.773 | 0.002 | 0.2 |
| Irradiance | | | | | | |
| Global 37° Tilt | 0.767 | 0.767 | 0.769 | 0.768 | 0.001 | 0.2 |
| Irradiance | | | | | | |
| Global Horizontal | 0.758 | 0.758 | 0.761 | 0.759 | 0.002 | 0.2 |
| Irradiance | | | | | | |

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A geosynthetic structure comprising:
a base resin polymeric matrix comprising an admixture;
a graphene material impregnated into the base resin polymer matrix and in a final amount of about 0.10 weight percent to about 5 weight percent; and
a stabilizer impregnated within the base resin polymer matrix.

2. The geosynthetic structure of claim 1, wherein the geosynthetic structure is a geomembrane, a geotextile, or a geonet.

3. The geosynthetic structure of claim 1, wherein the admixture of the base resin polymeric mixture comprises high density polyethylene, medium density polyethylene, linear low-density polyethylene, low density polyethylene, or a combination thereof.

4. The geosynthetic structure of claim 1, wherein the admixture of the base resin polymeric mixture comprises a polyolefin mixture.

5. The geosynthetic structure of claim 1, wherein the stabilizer is an antioxidant, a radical scavenger, a hindered amine light stabilizer, or a combination thereof.

6. The geosynthetic structure of claim 1, wherein the geosynthetic structure has a high pressure oxidative induction time increase of at least 15% compared to a same geosynthetic structure with a same base resin polymeric matrix and 2.5% carbon black instead of the graphene material, as measured by ASTM D5885 test method.

7. The geosynthetic structure of claim 1, wherein the base resin polymeric matrix includes polypropylene, polyethylene, polyvinyl chloride, acrylonitrile butadiene styrene, a plastomer, a viscoelastomer, a co-polymer of any of the foregoing, or a combination thereof.

8. The geosynthetic structure of claim 7, wherein the polyethylene is high density polyethylene, medium density polyethylene, low density polyethylene, linear low density polyethylene, ultra low density polyethylene, or any combination thereof.

9. The geosynthetic structure of claim 1, wherein the graphene material is in the form of graphene particles, graphene nanoparticles, graphene nanofillers, graphene nanocomposites, graphene platelets, graphene powder, graphene concentrate, graphene compound, graphene masterbatch, or a combination thereof.

10. The geosynthetic structure of claim 9, wherein the graphene material is in the form of graphene platelets.

11. The geosynthetic structure of claim 10, wherein the graphene platelets have a graphene purity of at least 90 percent at a thickness of about 1 to about 10 atomic layers.

12. The geosynthetic structure of claim 1, wherein the geosynthetic structure of claim 1 has a static dissipative of 1.0×10⁶ to 1.0×10¹¹ Ohms, as measured in accordance with ASTM D257 test method.

13. The geosynthetic structure of claim 1, wherein the geosynthetic structure of claim 1 has a conductivity of about or less than 1.0×10⁴ Ohms, as measured in accordance with ASTM D257 test method.

14. The geosynthetic structure of claim 1, wherein the geosynthetic structure of claim 1 has an insulative measurement of at least 1.0×10¹² Ohms, as measured in accordance with ASTM D257 test method.

15. The geosynthetic structure of claim 1, wherein the geosynthetic structure has at least 1.5 times higher solar reflective index when compared to a geosynthetic structure without graphene material as measured according to ASTM E903-20.

16. The geosynthetic structure of claim 1, wherein the geosynthetic structure has at least a 20% higher asperity height as measured by ASTM D7466 test compared to a geosynthetic structure with 2.5% carbon black.

17. A geosynthetic structure comprising:
a plurality of layers;
wherein at least one layer of the plurality of layers is a graphene layer and comprises:
a base resin polymeric matrix comprising an admixture;
a graphene material impregnated into the base resin polymer matrix and in a final amount of about 0.10 weight percent to about 5 weight percent; and
a stabilizer impregnated within the base resin polymer matrix.

18. The geosynthetic structure of claim 17, wherein at least one layer of the plurality of layers is substantially free of graphene.

19. The geosynthetic structure of claim 17, wherein the geosynthetic structure is a geomembrane; the plurality of layers include a core structure, a first skin structure, and a second skin structure; and the core structure is the graphene layer.

20. The geosynthetic structure of claim 19, wherein the first skin structure and the second skin structure have different polymer compositions, different textures, or both different polymer compositions and different textures.

21. The geosynthetic structure of claim 19, wherein the first skin, the second skin, or both is reflective; or the first skin, the second skin, or both is not reflective; wherein reflective means an average of least 50% solar energy reflectance as measured as direct normal irradiance according to ASTM E903-20 test method.

22. The geosynthetic structure of claim 22, wherein, when reflective, the first skin, the second skin, or both includes barium sulfate, titanium dioxide, zinc oxide, lead oxide, or a combination thereof.

23. The geosynthetic structure of claim 19, wherein the core structure, first skin, or second skin further includes carbon black.

24. The geosynthetic structure of claim 17, wherein the plurality of layers include a core structure, a first skin structure, and a second skin structure; and wherein one or more of the core structure, the first skin structure, or the second skin structure is substantially free of the graphene material.

25. The geosynthetic structure of claim 17, wherein the plurality of layers include a core structure, a first skin structure, and a second skin structure; and wherein one or more of the core structure, the first skin structure, or the second skin structure is insulative with an insulative measurement of at least 1.0×10¹² Ohms, as measured in accordance with ASTM D257 test method.

26. The geosynthetic structure of claim 17, wherein the plurality of layers include a core structure, a first skin structure, and a second skin structure; and wherein one or more of the core structure, the first skin structure, or the second skin structure is conductive with a conductivity equal to or less than 1.0×10⁴ Ohms, as measured in accordance with ASTM D257 test method.
